(19) United States
(12) Patent Application Publication
(10) Pub. No.: US 2011/0192918 A1
(43) Pub. Date: Aug. 11, 2011

(54) INJECTOR

(75) Inventors: Toshio JINNO, Kariya-city (JP); Yusaku Saito, Nagoya-city (JP)

(73) Assignee: DENSO CORPORATION, Kariya-city (JP)

(21) Appl. No.: 13/013,031

(22) Filed: Jan. 25, 2011

(30) Foreign Application Priority Data
Feb. 11, 2010 (JP) 2010-28304
Nov. 10, 2010 (JP) 2010-251595

(51) Int. Cl. B05B 1/30

(52) U.S. Cl. 239/584

(57) ABSTRACT

An injector includes an injection nozzle to inject high-pressure fuel, and a main part connected to the injection nozzle in an axis direction. The injection nozzle has a nozzle body, and a cylindrical member having an inner circumference face to support a nozzle needle slidable in the axis direction. The nozzle body has a cylinder to accommodate the nozzle needle and the cylindrical member. The cylindrical member is liquid-tightly connected to the main part in the axis direction. A sliding clearance is defined between the nozzle needle and the cylindrical member, and an annular fuel passage is defined between the cylinder and the cylindrical member.

### CROSS REFERENCE TO RELATED APPLICATION

This application is based on Japanese Patent Application No. 2010-28304 filed on Feb. 11, 2010 and Japanese Patent Application No. 2010-251595 filed on Nov. 10, 2010, the disclosures of which are incorporated herein by reference in their entirety.

### BACKGROUND OF THE INVENTION

The present invention relates to an injector.

An injector 100 injects fuel with high-pressure exceeding 100 MPa. As shown in FIG. 7A, the injector 100 includes an injection nozzle 101 to inject high-pressure fuel, a main part 102 and an electromagnetic actuator 103. The main part 102 receives high-pressure fuel from a fuel supply source, and introduces the fuel to the injection nozzle 101. The electromagnetic actuator 103 opens a valve of the injection nozzle 101. The injection nozzle 101 is connected to a tip end of the main part 102 in an axis direction, and the electromagnetic actuator 103 is connected to a rear end of the main part 102 in the axis direction.

As shown in FIG. 7B, the injection nozzle 101 includes a nozzle needle 105 and a nozzle body 106. The nozzle needle 105 opens or closes an injection hole 104 by being moved in the axis direction. The nozzle body 106 accommodates the nozzle needle 105 slidable in the axis direction. The nozzle needle 105 is supported by the nozzle body 106, and is biased in a valve-closing direction by a spring 107. A ring-shaped nozzle chamber 108 is defined between the nozzle needle 105 and the nozzle body 106.

A high-pressure passage 109 is connected to the nozzle chamber 108, and high-pressure fuel flows through the high-pressure passage 109. High-pressure fuel passing through the main part 102 is introduced into the nozzle chamber 108 through the high-pressure passage 109. The nozzle chamber 108 is a part of the high-pressure passage 109, and a fuel pressure of the nozzle chamber 108 makes the nozzle needle 105 to move in a valve-opening direction.

A control chamber 110 is defined at a rear end of the main part 102 in the axis direction, and controls a movement of the nozzle needle 105 in the axis direction. The high-pressure passage 109 is connected to the control chamber 110, and high-pressure fuel is also introduced into the control chamber 110. A fuel pressure of the control chamber 110 makes the nozzle needle 105 to move in the valve-closing direction through a command piston 111. The control chamber 110 is connected or disconnected to a low-pressure passage 112 by the actuator 103. The fuel pressure of the control chamber 110 is lowered when the control chamber 110 is connected to the low-pressure passage 112, and is raised when the control chamber 110 is disconnected from the low-pressure passage 112.

Low-pressure fuel flows through the low-pressure passage 112, and a fuel pressure of the low-pressure passage 112 is lower than that of the high-pressure passage 109. Fuel of the nozzle chamber 108 leaks into the low-pressure passage 112 through a sliding clearance SC1 defined between the nozzle body 106 and the nozzle needle 105. Fuel of the control chamber 110 leaks into the low-pressure passage 112 through a sliding clearance SC2 defined between a main body 113 of the main part 102 and the command piston 111. Thus, a pressure of fuel flowing into the low-pressure passage 112 is lowered.

When the electromagnetic actuator 103 is activated, the fuel pressure of the control chamber 110 is lowered, so that a force applied to the nozzle needle 105 becomes large in the valve-opening direction. Therefore, the nozzle needle 105 is moved in the valve-opening direction, and the injection hole 104 and the nozzle chamber 108 are connected with each other, so that fuel injection is started.

In contrast, when the electromagnetic actuator 103 is stopped, the fuel pressure of the control chamber 110 is raised, so that a force applied to the nozzle needle 105 becomes large in the valve-closing direction. Therefore, the nozzle needle 105 is moved in the valve-closing direction, and the injection hole 104 and the nozzle chamber 108 are disconnected from each other, so that fuel injection is stopped.

The following situations are predicted for the injection nozzle 101 of the injector 100 as the fuel injection pressure is made higher.

As shown in FIG. 7B, a rear portion 114 of the nozzle needle 105 is directly supported by the nozzle body 106 in slidable state, and the nozzle chamber 108 is defined between the nozzle body 106 and a front portion 115 of the nozzle needle 105, thereby the number of components constructing the injection nozzle 101 is reduced to two, that is, the nozzle needle 105 and the nozzle body 106.

A rear portion 116 of the nozzle chamber 108 is made larger in a radial direction, and high-pressure fuel is supplied from the high-pressure passage 109 of the main part 102 into the nozzle chamber 108. The rear portion 116 may be renamed as a bag-shaped hole 116.

A fuel passage 117 corresponding to a part of the high-pressure passage 109 is connected to the rear portion 116. The fuel passage 117 extends in linear state, and is inclined relative to the axis direction. The fuel passage 117 may be renamed as a side passage 117.

A projection 118 protruding into the high-pressure passage 109 is generated by connecting the bag-shaped hole 116 and the side passage 117. Stress concentration may occur at the projection 118. In this case, the pressure-withstanding property will be lowered. This situation will be much generated as the fuel injection pressure is made higher.

Fuel of the nozzle chamber 108 leaks into the low-pressure passage 112 through the sliding clearance SC1 between the rear portion 114 of the nozzle needle 105 and the nozzle body 106. As the fuel injection pressure is made higher, a pressure of fuel passing through the sliding clearance SC1 is also made higher, so that the sliding clearance SC1 may be expanded in the radial direction. In this case, an amount of fuel leaking from the nozzle chamber 108 into the low-pressure passage 112 may be increased. This situation will be much generated as the fuel injection pressure is made higher.

JP-A-2006-194173 discloses such a bag-shaped hole, and a projection having an obtuse angle is generated by connecting the bag-shaped hole and a side passage. Stress concentration generated at the projection can be eased by the obtuse angle. However, a processing for providing such a bag-shaped hole is complicated so that a cost of the processing becomes high, compared with a case where a projection generated by connecting the bag-shaped hole and the side passage is made to have an acute angle. Moreover, the stress concentration is not completely eliminated even if the projection is made to have the obtuse angle. The stress concentration will be remained as disadvantage, as the fuel injection pressure is made much higher.

### SUMMARY OF THE INVENTION

In view of the foregoing and other problems it is an object of the present invention to provide an injector.

According to an example of the present invention, an injector includes a main part and an injection nozzle connected to the main part in an axis direction. The main part has a high-pressure passage through which high-pressure fuel flows from a fuel supply source and a low-pressure passage through which low-pressure fuel flows. A pressure of the low-pressure fuel is lower than a pressure of the high-pressure fuel. The injection nozzle includes a nozzle body, a nozzle needle, a cylindrical member and a biasing portion. The nozzle body has an injection hole to inject high-pressure fuel. The nozzle needle opens or closes the injection hole by being moved in the axis direction. The cylindrical member has an inner circumference face to support the nozzle needle slidable in the axis direction. A sliding clearance is defined between the nozzle needle and the cylindrical member. The biasing portion biases the cylindrical member toward the main part in the axis direction. The nozzle body has a cylinder to accommodate the nozzle needle, the cylindrical member and the biasing portion. The cylinder is located on an end portion of the nozzle body adjacent to the main part in the axis direction. An annular fuel passage to communicate with the high-pressure passage of the main part is defined between the cylinder and the cylindrical member. The cylindrical member is liquid-tightly connected to the main part in the axis direction, such that the sliding clearance causes a pressure of fuel of the annular fuel passage to be lowered, and that the pressure-lowered fuel flows into the low-pressure passage of the main part.

Accordingly, fuel injection pressure of the injector can be made higher.

### BRIEF DESCRIPTION OF THE DRAWINGS

The above and other objects, features and advantages of the present invention will become more apparent from the following detailed description made with reference to the accompanying drawings. In the drawings:

FIG. 1A is a cross-sectional view illustrating an injector according to a first embodiment, and FIG. 1B is an enlarged view of FIG. 1A;

FIG. 2 is an enlarged cross-sectional view illustrating an injector according to a second embodiment;

FIG. 3 is an enlarged cross-sectional view illustrating an injector according to a third embodiment;

FIG. 4 is an enlarged cross-sectional view illustrating an injector according to a fourth embodiment;

FIG. 5 is an enlarged cross-sectional view illustrating an injector according to a fifth embodiment;

FIG. 6 is an enlarged cross-sectional view illustrating an injector according to a seventh embodiment; and

FIG. 7A is a cross-sectional view illustrating a conventional injector, and FIG. 7B is an enlarged view of FIG. 7A.

### DETAILED DESCRIPTION OF PREFERRED EMBODIMENT

### First Embodiment

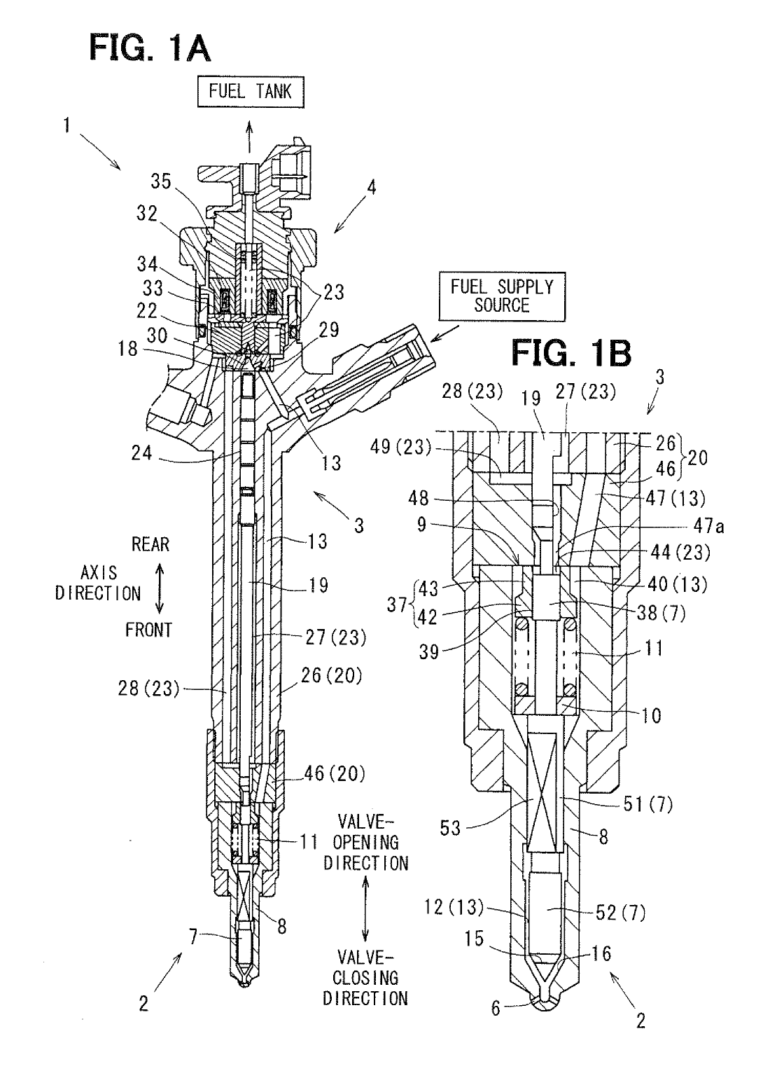

An injector 1 of a first embodiment will be described with reference to FIGS. 1A and 1B. For example, the injector 1 directly injects fuel into a cylinder of a diesel engine (not shown) with high-pressure exceeding 100 MPa.

As shown in FIG. 1A, the injector 1 includes an injection nozzle 2 to inject high-pressure fuel, a main part 3 and an electromagnetic actuator 4. The main part 3 receives high-pressure fuel from a fuel supply source such as a common rail, and introduces the fuel to the injection nozzle 2. The actuator 4 opens a valve of the injection nozzle 2. The injection nozzle 2 is connected to a front end of the main part 3 in an axis direction, and the actuator 4 is connected to a rear end of the main part 3 in the axis direction. The front and rear directions are defined only for convenience, and are not limited in an actual arrangement. The front direction corresponds to a tip end side of the injector 1 to inject fuel, and the rear direction is defined to be opposite from the front direction.

As shown in FIG. 1B, the injection nozzle 2 includes a nozzle needle 7 and a nozzle body 8. The nozzle body 8 has an injection hole 6, and the nozzle needle 7 opens or closes the nozzle hole 6 by being moved in the axis direction. The nozzle body 8 accommodates the nozzle needle 7 movable in the axis direction. A rear end portion of the nozzle body 8 is made of a cylinder 9 formed into an approximately cylindrical shape, and has an opening extending in the axis direction. The nozzle needle 7 is accommodated in the cylinder 9, and is biased in a valve-closing direction by a spring 11 through a shim 10. A ring-shaped nozzle chamber 12 is defined between the nozzle needle 7 and the nozzle body 8.

High-pressure fuel is introduced into the nozzle chamber 12 from a high-pressure passage 13 of the main part 3. The nozzle chamber 12 corresponds to a part of the high-pressure passage 13 through which high-pressure fuel flows, and a fuel pressure of the nozzle chamber 12 makes the nozzle needle 7 to move in a valve-opening direction. High-pressure fuel flowing from the fuel supply source passes through the high-pressure passage 13 without pressure-lowering.

A seat part 15 is defined on a front tip of the nozzle needle 7, and a seat face 16 is defined on an inner face of the nozzle body 8 opposing to the seat part 15. The seat part 15 is seated on or separated from the seat face 16. A front end of the nozzle body 8 has the nozzle hole 6. The nozzle hole 6 is located more front side than the seat face 16. The nozzle hole 6 and the nozzle chamber 12 are connected with each other when the seat part 15 is separated from the seat face 16, and are disconnected from each other when the seat part 15 is seated on the seat face 16, thereby fuel injection through the nozzle hole 6 is started or stopped.

As shown in FIG. 1A, a rear end portion of the main part 3 has a control chamber 18 to control a movement of the nozzle needle 7 in the axis direction. The main part 3 has a command piston 19 to transmit a fuel pressure of the control chamber 18 into the nozzle needle 7. The fuel pressure of the control chamber 18 makes the nozzle needle 7 to move in the valve-closing direction through the command piston 19. A body 20 of the main part 3 has the high-pressure passage 13 to introduce high-pressure fuel from the fuel supply source toward the injection nozzle 2. The high-pressure passage 13 is branched, and the branched passage is connected to the control chamber 18. High-pressure fuel is also introduced into the control chamber 18.

The control chamber 18 is connected or disconnected to a low-pressure passage 23 defined in the actuator 4 by a valve 22 of the actuator 4. A pressure of fuel flowing through the low-pressure passage 23 is lower than that flowing through the high-pressure passage 13. Fuel passing through the high-pressure passage 13 has pressure-lowering while passing through narrow clearances. The pressure-lowered fuel flows through the low-pressure passage 23 with pressure-lowered state.

The body 20 of the main part 3 supports a rear end portion of the command piston 19 in slidable state, and a front side of the control chamber 18 is sealed by the command piston 19. High-pressure fuel of the control chamber 18 leaks into the low-pressure passage 23 through a sliding clearance 24 defined between the body 20 and the command piston 19. The main part 3 also has the low-pressure passage 23 mainly constructed by a ring passage 27 and a penetration passage 28. The body 20 of the main part 3 has a front portion 46 and a rear portion 26. The ring passage 27 is defined between the rear portion 26 of the body 20 and the command piston 19. The penetration passage 28 extends through the rear portion 26 of the body 20 in the axis direction, parallel to the ring passage 27.

Fuel leaks into the ring passage 27 through the sliding clearance 24, and the leaking fuel flows into the penetration passage 28. At this time, the flowing direction of fuel is reversed at a front end of the rear portion 26 of the body 20. Fuel of the penetration passage 28 flows into the low-pressure passage 23 of the actuator 4, and is returned into a fuel tank corresponding outside of the injector 1 from a rear end of the actuator 4.

If the control chamber 18 is connected to the low-pressure passage 23, the fuel pressure of the control chamber 18 is lowered. If the control chamber 18 is disconnected from the low-pressure passage 23, the fuel pressure of the control chamber 18 is raised. An orifice 29 is arranged in a passage extending from the high-pressure passage 13 to the control chamber 18. An orifice 30 is arranged in a passage extending from the control chamber 18 to the low-pressure passage 23. Due to the orifices 29 and 30, the fuel pressure of the control chamber 18 is suitably lowered or raised by opening or closing the valve 22.

The electromagnetic actuator 4 has an armature 33 and a stator 34 to form a magnetic circuit when electricity is supplied to a solenoid coil 32. The valve 22 is supported at a front tip of a sliding shaft integrated with the armature 33 in the axis direction. The armature 33 is biased by a spring 35 in a direction separating from the stator 34.

When electricity starts to be supplied to the solenoid coil 32, the armature 33 is attracted toward the stator 34, and the valve 22 is moved rearward in the axis direction, such that the control chamber 18 is connected to the low-pressure passage 23.

When the electricity supplying to the solenoid coil 32 is stopped, the armature 33 is moved away from the stator 34, and the valve 22 is moved frontward in the axis direction, such that the control chamber 18 is disconnected from the low-pressure passage 23.

When electricity starts to be supplied to the solenoid coil 32, the electromagnetic actuator 4 is activated, and the fuel pressure of the control chamber 18 is lowered, so that a force applied to the nozzle needle 7 becomes large in the valve-opening direction. Therefore, the nozzle needle 7 is moved in the valve-opening direction, and the injection hole 6 and the nozzle chamber 12 are connected with each other, so that fuel injection is started.

In contrast, when the electricity supplying to the solenoid coil 32 is stopped, the electromagnetic actuator 4 is stopped, and the fuel pressure of the control chamber 18 is raised, so that the force applied to the nozzle needle 7 becomes large in the valve-closing direction. Therefore, the nozzle needle 7 is moved in the valve-closing direction, and the injection hole 6 and the nozzle chamber 12 are disconnected from each other, so that fuel injection is stopped.

As shown in FIG. 1B, the injection nozzle 2 has a cylindrical member 37 other than the cylinder 9 of the nozzle body 8. The cylindrical member 37 supports a rear part 38 of the nozzle needle 7 slidable in the axis direction, and a sliding clearance 39 is defined between the nozzle needle 7 and the cylindrical member 37. The cylindrical member 37 is accommodated in the cylinder 9 of the nozzle body 8 together with the nozzle needle 7, and an annular fuel passage 40 is defined between the cylinder 9 of the nozzle body 8 and the cylindrical member 37.

The high-pressure passage 13 is opened on a front end of the main part 3 in the axis direction. When the main part 3 and the injection nozzle 2 are connected with each other, the annular passage 40 communicates with the high-pressure passage 13 of the main part 3, thereby the annular passage 40 corresponds to a part of the high-pressure passage 13. The annular passage 40 may be called a nozzle-side annular high-pressure passage 40. The spring 11 is accommodated in the annular passage 40.

An outer diameter of a front part 42 of the cylindrical member 37 is made larger than that of a rear part 43 of the cylindrical member 37. The front part 42 of the cylindrical member 37 corresponds to a spring seat to support the spring 11 in the axis direction, together with the shim 10. The cylindrical member 37 is biased toward the main part 3 in the axis direction by the spring 11, and liquid-tightly contacts the front end of the main part 3 in the axis direction.

Therefore, an inner circumference side of the cylindrical member 37 is liquid-tightly separated from the high-pressure passage 13. A space inside of the cylindrical member 37 communicates with the low-pressure passage 23 of the main part 3 when the main part 3 is connected to the injection nozzle 2, and corresponds to a part of the low-pressure passage 23. The low-pressure passage 23 inside of the cylindrical member 37 is defined as a nozzle-side low-pressure passage 44.

When fuel flows from the annular high-pressure passage 40 into the low-pressure passage 44 through the sliding clearance 39 between the cylindrical member 37 and the nozzle needle 7, a pressure of the fuel is lowered. A front tip of the command piston 19 is contact with a rear end of the nozzle needle 7 in the low-pressure passage 44, thereby a biasing force is transmitted by the command piston 19 from fuel of the control chamber 18 to the nozzle needle 7.

The high-pressure passage 13 of the main part 3 and the nozzle-side annular high-pressure passage 40 easily communicate with each other in the injector 1.

The outer diameter of the rear part 43 of the cylindrical member 37 is made smaller than that of the front part 42 of the cylindrical member 37. A rear-side cross-sectional area of the annular passage 40 defined between the rear part 43 and the nozzle body 8 is made larger than a front-side cross-sectional area of the annular passage 40 defined between the front part 42 and the nozzle body 8.

The body 20 of the main part 3 is constructed by the rear portion 26 and the front portion 46. The high-pressure passage 13 extending through the front portion 46 is inward inclined relative to the axis direction. The high-pressure passage 13 of the front portion 46 is defined as an inclined high-pressure passage 47.

The low-pressure passage 23 extending through the front portion 46 in the axis direction is located at a center section in a radial direction. The low-pressure passage 23 of the front portion 46 is defined as a front-side center low-pressure passage 47a. The center passage 47a and the nozzle-side low-pressure passage 44 communicate with each other when the main part 3 is connected to the injection nozzle 2, thereby the nozzle-side low-pressure passage 44 corresponds to a part of the low-pressure passage 23.

The front portion 46 of the main part 3 slidably supports the command piston 19 in a state that a front portion of the command piston 19 extends through the center passage 47a. The command piston 19 is slidably supported between the front portion and a rear portion. The front portion of the command piston 19 has a flat face 48 parallel to the axis direction by chamfering the outer circumference face, so that fuel can easily pass through the center passage 47a. Thus, fuel flexibly flows between the nozzle-side low-pressure passage 44 and the penetration low-pressure passage 28 of the main part 3. The front portion of the command piston 19 protrudes into the nozzle-side low-pressure passage 44 from the center passage 47a, and contacts the rear end of the nozzle needle 7 in the nozzle-side low-pressure passage 44.

Therefore, fuel leaking through the sliding clearance 39 passes through the nozzle-side low-pressure passage 44 and the center low-pressure passage 47a of the main part 3, and flows into the penetration passage 28 of the main part 3. A rear end part of the front portion 46 has a recess 49 recessed in the axis direction. Due to the recess 49, the ring passage 27 and the penetration passage 28 communicate with each other. The recess 49 corresponds to the low-pressure passage 23. The center passage 47a is connected to the recess 49. Fuel passing through the center passage 47a flows into the penetration passage 28 through the recess 49.

The nozzle body 8 is constructed by a front part, a middle part and a rear part corresponding to the cylinder 9 arranged in the axis direction. An outer diameter of the nozzle body 8 is made smaller in order of the rear part, the center part and the front part. The nozzle needle 7 is slidably supported by the center part of the nozzle body 8. Further, the nozzle chamber 12 is defined between a front part 52 of the nozzle needle 7 and the front part of the nozzle body 8. The nozzle needle 7 is constructed by the front part 52, a center part 51 and a rear part 38. The front part 52 is located on the front side than the center part 51 contact with the nozzle body 8. The center part 51 has a flat face 53 parallel to the axis direction by chamfering the outer circumference face, so that the nozzle-side annular passage 40 and the nozzle chamber 12 communicate with each other.

According to the first embodiment, the injection nozzle 2 has the cylindrical member 37 to support the nozzle needle 7 slidable in the axis direction, so that the sliding clearance 39 is defined between the nozzle needle 7 and the cylindrical member 37. The nozzle needle 7 and the cylindrical member 37 are accommodated in the cylinder 9 of the nozzle body 8. The nozzle-side annular high-pressure passage 40 is defined between the cylindrical member 37 and the nozzle body 8, and communicates with the inclined high-pressure passage 47 of the main part 3.

The cylindrical member 37 is biased rearward in the axis direction by the spring 11, and contacts the front end of the main part 3 in the axis direction, thereby forming the nozzle-side low-pressure passage 44 inside of the cylindrical member 37. Further, the nozzle-side low-pressure passage 44 and the nozzle-side annular high-pressure passage 40 are liquid-tightly separated from each other. A pressure of fuel flowing from the annular high-pressure passage 40 is lowered by the sliding clearance 39, and the pressure-lowered fuel flows into the nozzle-side low-pressure passage 44.

Therefore, a bag-shaped hole nor a side passage is unnecessary for the high-pressure passage 13. High-pressure fuel can be supplied to the injection nozzle 2, due to the communication between the annular passage 40 and the inclined passage 47. Thus, the fuel injection pressure can be made higher without considering a lowing of pressure-withstanding property by a projection generated by connecting the bag-shaped hole and the side passage.

Even if the pressure of fuel passing through the sliding clearance 39 is made higher as the fuel injection pressure is made higher, the sliding clearance 39 is not expanded because high-pressure is applied by fuel to the cylindrical member 37 from the outer circumference side. Thus, even if the fuel injection pressure is made higher, the pressure-withstanding property can be maintained high, and the sliding clearance 39 around the nozzle needle 7 can be prevented from being expanded.

### Second Embodiment

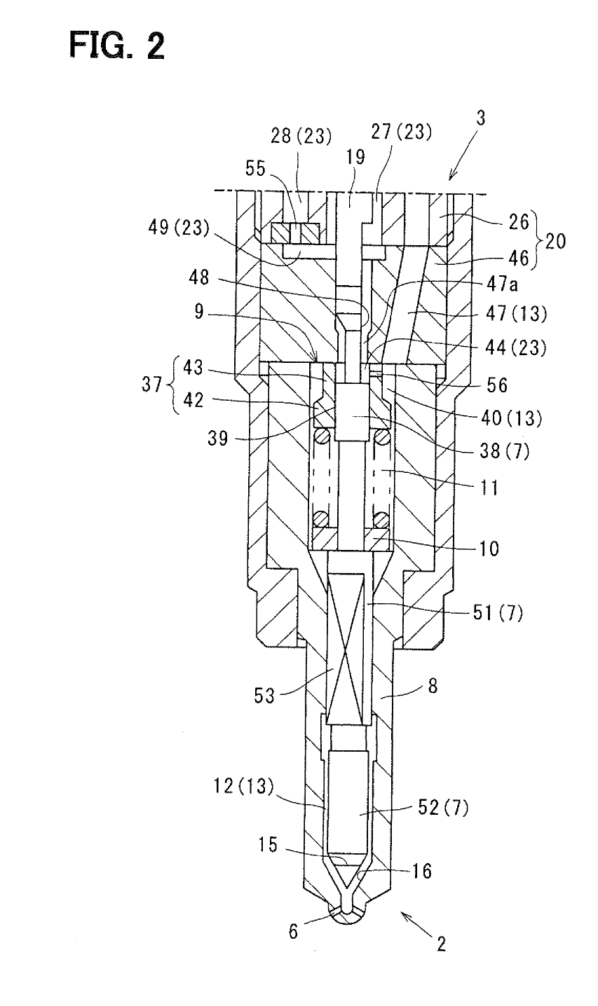

As shown in FIG. 2, a main part 3 has a throttle 55 located in a penetration low-pressure passage 28. The penetration low-pressure passage 28 communicates with a low-pressure passage 23 of a front portion 46 of the main part 3 through the throttle 55. The low-pressure passage 23 corresponds to a center passage 47a and a recess 49, for example. Therefore, after a pressure of fuel is lowered by passing through a sliding clearance 24, 39, a pressure of the pressure-lowered fuel is raised by the throttle 55 before flowing into the penetration passage 28.

Further, a rear part 43 of the cylindrical member 37 has a communication passage 56 through which a high-pressure passage 40 and a low-pressure passage 44 communicate with each other. A pressure of fuel flowing through the high-pressure passage 40 is lowered by passing through the communication passage 56, and the pressure-lowered fuel flows into the low-pressure passage 44. The communication passage 56 may be defined as a throttle 56.

Therefore, the fuel pressure of the nozzle-side low-pressure passage 44 and the fuel pressure of the low-pressure passage 23 of the front portion 46 are maintained as a middle pressure. The middle pressure is higher than the fuel pressure of the penetration passage 28 downstream of the throttle 55, and is lower than the fuel pressure of the high-pressure passage 13.

The fuel pressure of the nozzle-side low-pressure passage 44 becomes higher compared with a case where the throttle 55, 56 is not provided. Forces applied to the rear part 43 of the cylindrical member 37 in the radial direction are balanced in a state that the force applied from inside to outside by fuel of the low-pressure passage 44 corresponds to the force applied from outside to inside by fuel of the high-pressure passage 40.

Thus, the rear part 43 can be prevented from being deformed inward by the pressure difference between the high-pressure passage 40 and the low-pressure passage 44. The middle pressure is set lower than the fuel pressure of the control chamber 18, even if the fuel pressure of the control chamber 18 is lowered by being connected to the low-pressure passage 23.

### Third Embodiment

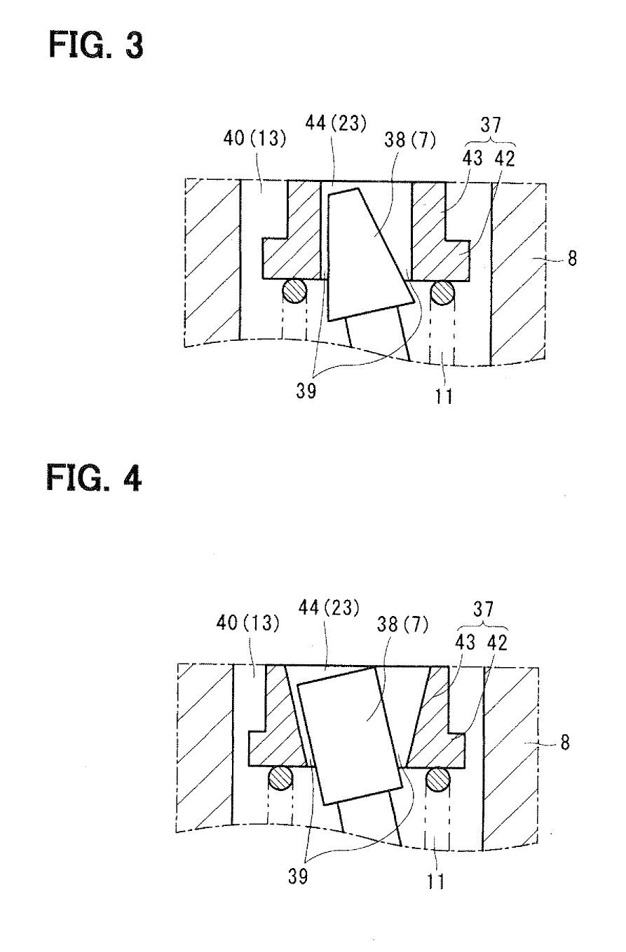

As shown in FIG. 3, an outer circumference face of a rear part 38 of a nozzle needle 7 is tapered rearward in the axis direction. That is, an outer diameter of the nozzle needle 7 is made smaller, and a sliding clearance 39 is made larger, as the nozzle needle 7 extends toward a main part 3 in the axis direction. Even if the nozzle needle 7 becomes inclined relative to the axis direction while moving in the axis direction, the sliding clearance 39 can be secured to have a minimum size. Further, a cylindrical member 37 can be prevented from three-dimensionally interfering with the nozzle needle 7.

### Fourth Embodiment

As shown in FIG. 4, an inner circumference face of a cylindrical member 37 is tapered frontward in the axis direction. That is, an inner diameter of the cylindrical member 37 is made larger, and a sliding clearance 39 is made larger, as the cylindrical member 37 extends rearward in the axis direction. Therefore, similar to the third embodiment, the sliding clearance 39 can be secured to have a minimum size. Further, the cylindrical member 37 can be prevented from three-dimensionally interfering with a nozzle needle 7.

### Fifth Embodiment

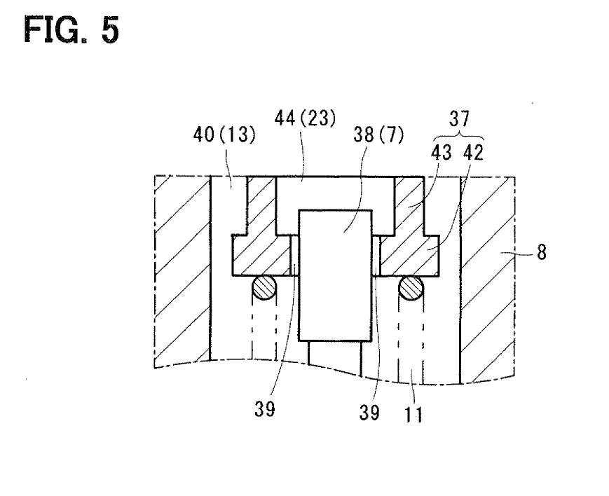

As shown in FIG. 5, an inner diameter of a cylindrical member 37 is made larger in a rear part 43 than in a front part 42. A sliding clearance 39 is defined between an inner circumference face of the front part 42 of the cylindrical member and the nozzle needle 7. Therefore, if the rear part 43 of the cylindrical member 37 is deformed inward by a pressure difference between a high-pressure passage 40 and a low-pressure passage 44, the rear part 43 can be prevented from three-dimensionally interfering with the nozzle needle 7.

### Sixth Embodiment

A cylindrical member 37 is made of high-strength ceramics such as silicon nitride having rigidity higher than that of steel. Therefore, a rear part 43 of the cylindrical member 37 can be prevented from being deformed inward by a pressure difference between a high-pressure passage 40 and a low-pressure passage 44.

### Seventh Embodiment

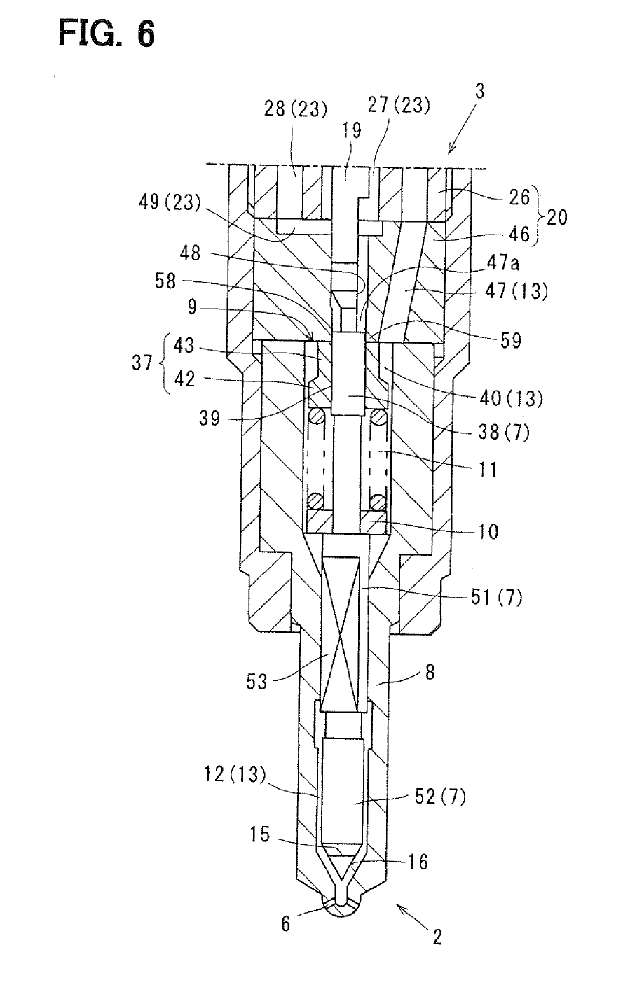

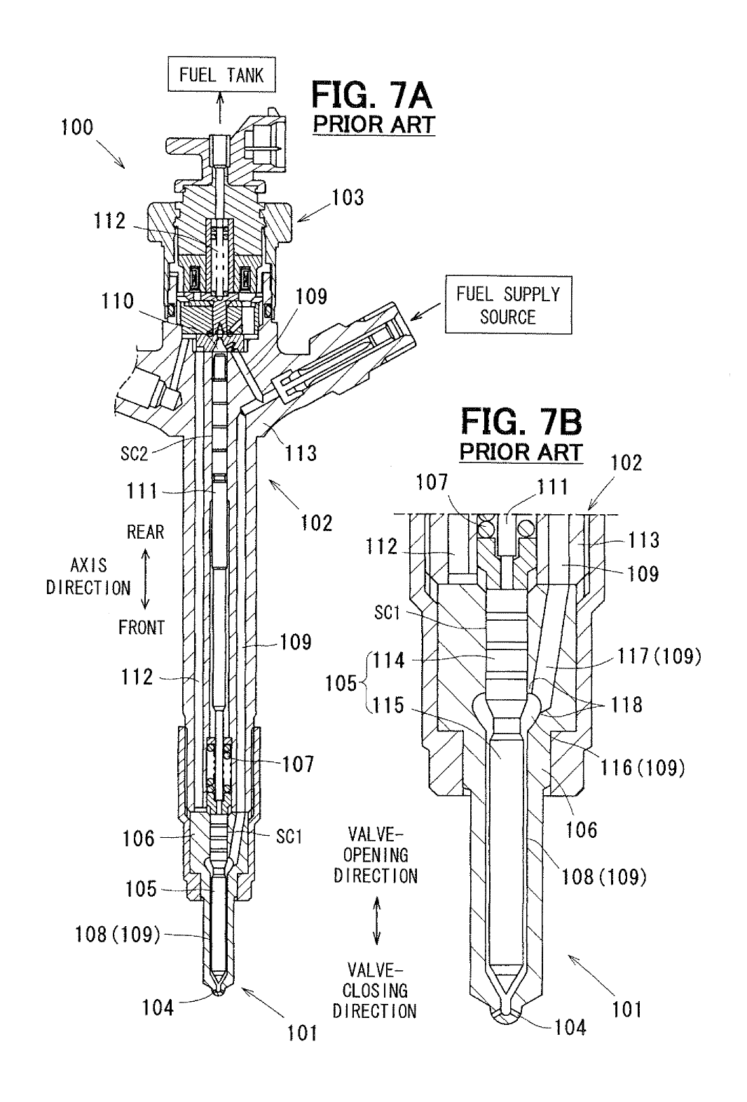

As shown in FIG. 6, a rear part 38 of a nozzle needle 7 protrudes from a cylindrical member 37 toward a main part 3 in the axis direction. The rear part 38 is fitted with a center passage 47a, and is slidably supported by a front portion 46 of the main part 3. Because the center passage 47a is sealed by the rear part 38, the nozzle-side low-pressure passage 44 is eliminated on the inner circumference side of the cylindrical member 37.

The sliding clearance 39 defined between the nozzle needle 7 and the cylindrical member 37 may correspond to a first clearance 39. A sliding clearance defined between the nozzle needle 7 and the front portion 46 of the main part 3 is defined as a second clearance 58. The second clearance 58 is set narrower than the first clearance 39. A pressure of fuel passing through the high-pressure passage 13 is lowered by the first and second clearances 39, 58, and the pressure-lowered fuel flows into the center passage 47a.

Therefore, when the fuel pressure of the high-pressure passage 13 is high, a fuel leakage from the high-pressure passage 13 to the low-pressure passage 23 can be reduced by the first sliding clearance 39. Further, when the fuel pressure of the high-pressure passage 13 is middle or low, the fuel leakage from the high-pressure passage 13 to the low-pressure passage 23 can be reduced by the second sliding clearance 58. Thus, the fuel leakage can be maintained as small even if the fuel injection pressure is widely changed to high-pressure exceeding 150 MPa from low or middle pressure such as 20 MPa-100 MPa at the time of idling, for example.

That is in a case where the nozzle-side low-pressure passage 44 is defined inside of the cylindrical member 37 in a state that the rear part 38 of the nozzle needle 7 is not slidably supported by the front portion 46 of the main part 3, the rear part 43 of the cylindrical member 37 may be deformed inward by a pressure difference between the high-pressure passage 40 and the low-pressure passage 44. As the fuel pressure of the high-pressure passage 13 is made higher, the deformation amount of the rear part 43 becomes larger, and the first sliding clearance 39 becomes narrower.

In this case, a caught-in phenomenon may be easily generated, in which the nozzle needle 7 cannot move in the axis direction when the cylindrical member 37 is deformed inward.

The first sliding clearance 39 is set larger considering the deformation amount of the rear part 43 generated when the injection pressure is high, because the caught-in phenomenon may be easily generated in this case. Therefore, even if the deformation amount of the rear part 43 becomes large due to the high injection pressure, the caught-in phenomenon can be reduced, and the fuel leakage generated through the first sliding clearance 39 can be reduced.

When the first sliding clearance 39 is set larger, the deformation amount of the rear part 43 becomes smaller if the fuel injection pressure is middle or low. In this case, the fuel leakage generated through the first sliding clearance 39 is increased. Therefore, the second sliding clearance 58 is set smaller than the first sliding clearance 39. Thus, when the injection pressure is middle or low, the fuel leakage from the first sliding clearance 39 into the center passage 47a can be reduced by the second sliding clearance 58.

The front portion 46 of the main part 3 has a wall 59 between the center passage 47a and the inclined passage 47, and the wall 59 slidably supports the rear part 38 of the nozzle needle 7. The rear part 38 has a section located in the main part 3, and the section receives fuel pressure to inward deform the rear part 38 from the inclined high-pressure passage 47 only through the wall 59 between the center passage 47a and the inclined passage 47.

That is, the wall 59 is a predetermined section of a ring shape to surround the center passage 47a. High-pressure of fuel to generate the deformation is transmitted from the high-pressure passage 47 only to the wall 59 having a circumference direction coordinate corresponding to the inclined high-pressure passage 47, if the circumference direction coordinate is defined to have a center axis corresponding to a center axis of the center passage 47a. The other section other than the wall 59 does not receive the high-pressure to generate the deformation. Therefore, in this case, the caught-in phenomenon is less generated in the front portion 46 of the main part 3 if the fuel injection pressure is made higher.

### (Modification)

The injector 1 of the present invention is not limited to the first to seventh embodiments. For example, according to the injector 1 of the second embodiment, the throttle 56 may be eliminated, if the middle pressure is achieved only by the throttle 55.

Such changes and modifications are to be understood as being within the scope of the present invention as defined by the appended claims.

What is claimed is:

1. An injector comprising:
a main part having a high-pressure passage through which high-pressure fuel flows from a fuel supply source and a low-pressure passage through which low-pressure fuel flows, a pressure of the low-pressure fuel being lower than a pressure of the high-pressure fuel; and
an injection nozzle connected to the main part in an axis direction, the injection nozzle including
a nozzle body having an injection hole to inject high-pressure fuel,
a nozzle needle to open or close the injection hole by being moved in the axis direction,
a cylindrical member having an inner circumference face to support the nozzle needle slidable in the axis direction, a sliding clearance being defined between the nozzle needle and the cylindrical member, and
a biasing portion to bias the cylindrical member toward the main part in the axis direction, wherein
the nozzle body has a cylinder to accommodate the nozzle needle, the cylindrical member and the biasing portion,
the cylinder is located on an end portion of the nozzle body adjacent to the main part in the axis direction, an annular fuel passage to communicate with the high-pressure passage of the main part being defined between the cylinder and the cylindrical member, and
the cylindrical member is liquid-tightly connected to the main part in the axis direction, such that the sliding clearance causes a pressure of fuel of the annular fuel passage to be lowered, and that the pressure-lowered fuel flows into the low-pressure passage of the main part.

2. The injector according to claim 1, wherein
the cylindrical member liquid-tightly contacts the main part so as to define a low-pressure passage inside of the cylindrical member, and
the injection nozzle is connected to the main part in a manner that the low-pressure passage of the cylindrical member communicates with the low-pressure passage of the main part, such that fuel passing through the low-pressure passage of the cylindrical member from the sliding clearance flows into the low-pressure passage of the main part.

3. The injector according to claim 2, further comprising:
a throttle located in the low-pressure passage of the main part, wherein
the throttle narrows a flow of fuel flowing toward the main part from the injection nozzle through the low-pressure passage of the cylindrical member.

4. The injector according to claim 1, wherein
the nozzle needle has an outer circumference face defining the sliding clearance, and
the outer circumference face of the nozzle needle has a diameter to become smaller as the nozzle needle extends toward the main part in a taper shape.

5. The injector according to claim 1, wherein
the cylindrical member has an inner circumference face defining the sliding clearance, and
the inner circumference face of the cylindrical member has a diameter to become larger as the cylindrical member extends toward the main part.

6. The injector according to claim 1, wherein
the cylindrical member has an outer diameter to become smaller as the cylindrical member extends toward the main part in the axis direction,
the cylindrical member has a first inner circumference face defining the sliding clearance, and
the cylindrical member has a second inner circumference face located adjacent to the main part than the first inner circumference face, and a diameter of the second inner circumference face is larger than a diameter of the first inner circumference face.

7. The injector according to claim 1, wherein
the cylindrical member is made of ceramics.

8. The injector according to claim 1, wherein
the nozzle needle has an end portion protruded from the cylindrical member toward the main part in the axis direction,
the injection nozzle is connected to the main part in a manner that the end portion of the nozzle needle is fitted with the low-pressure passage of the main part,
the sliding clearance between the nozzle needle and the cylindrical member corresponds to a first clearance, and a second clearance is defined between the main part and the end portion of the nozzle needle when the end portion of the nozzle needle seals the low-pressure passage,
the second clearance is narrower than the first clearance, and
the first and second clearances cause a pressure of fuel passing through the annular fuel passage of the injection nozzle to be lowered, and the pressure-lowered fuel flows into the low-pressure passage of the main part.
